(19) United States
(12) Patent Application Publication
(10) Pub. No.: US 2008/0273175 A1
(43) Pub. Date: Nov. 6, 2008

(54) Method for Optical Projection of Profiles on a Work Surface of a Machine for Automatic Cutting of Flat Articles

(75) Inventor: Gianni Gallucci, Monte Urano (AP) (IT)

Correspondence Address: WILLIAM J. SAPONE;COLEMAN SUDOL SAPONE P.C., 714 COLORADO AVENUE, BRIDGE PORT, CT, 06605, US

(73) Assignee: TESEO S.P.A., Fermo (IT)

(21) Appl. No.: 11/911,796

(22) PCT Filed: Apr. 26, 2006
(86) PCT No.: PCT/IB06/01022

§ 371 Date: Oct. 17, 2007

(30) Foreign Application Priority Data
Apr. 26, 2005 (IT) BO2005A 000282

(51) Int. Cl. G03B 21/26; B26D 7/27

(52) U.S. Cl. 353/28; 83/522.16

(57) ABSTRACT

A method for the optical projection of profiles on the work surface (1) of a machine (100) for automatic cutting of flat articles (2) includes the following operation steps:
positioning of a flat article (2) on the work surface;
definition of a profile (3, 3A) on the flat article (2) by the projection, on the latter, of a first light beam (4);
orientation by rotation, with respect to an axis orthogonal to the surface (1), and positioning of the profile (3, 3A) on the flat article (2), and selection of the profile;
definition of the profile (3, 3A) on the flat article by the permanent optical projection thereon of a second light beam (5), and contemporary deactivation of the first light beam (4). The invention further proposes a machine for automatic cutting of flat articles with two projectors as required by the method.

### FIELD OF THE INVENTION

The present invention relates to a method for optical projection of profiles on a work surface of a machine for automatic cutting of flat articles, e.g. of leather or similar articles, used mainly in the footwear production.

### BACKGROUND OF THE INVENTION

Leather articles, in particular footwear, are usually produced by cutting flat pieces out from a leather of big dimensions, which has generally irregular shape: therefore, it is necessary to examine each time the number, the dimension and the best arrangement of the pieces to cut out, so as to occupy as big surface of the leather as possible, without overlapping the articles profiles, in order to reduce waste.

At present, the above operations are performed automatically, by cutting machines assisted by a processor.

In particular, there are cutting machines having a big work surface, above which a tool supporting carriage is operated.

A matrix-type projector projects the profiles on the leather, one at a time: the arrangement of the profiles on the work surface is set by an operator and shown, in reduced scale, on a monitor.

In this way, the operator can see directly the actual arrangement of the profiles on the leather spread on the work surface.

During these operations, the work surface is lighted by the projector light, which defines the profiles, selected previously by the operator on the leather, as well as the profile being positioned by the operator.

This allows the positioning of subsequent profiles to be made easy and possible overlapping of two or more adjacent profiles to be prevented.

Moreover, the work environment must be lighted very well, in order to allow the operator to find possible areas of the leather, having flaws and to avoid positioning of one or more profiles just in these areas, which would result, as it is known, in rejection of the corresponding articles.

On the other hand, a strong lighting of the work surface can cause problems to the operator, when he must work on the dark and/or shiny leathers.

Actually, these features of the leather, combined with the strong environment lighting and with the projector light beam, which hits the leather, could prevent the operator's distinct finding of the edges of the projected profile and of the profiles already selected and thus lighted.

Therefore, in these conditions, the operator is subjected to big tiredness (mostly affecting his sight), which can result in a missing optimization of the profiles positioning, with consequent increase of waste.

An alternative to the above described technical solution, using a matrix projector, can be the definition of the profiles on the leather by a laser beam.

This technique, although expensive, allows to work with a uniform lighting of the environment, and thus of the work surface, consequently eliminating the disadvantage concerning the use of dark and/or shiny leathers.

The operator using the laser beam in such lighting conditions, can find possible surface flaws of the leather, as well as the edges of the profile being positioned.

Using this technique, the profiles already positioned by the operator do not remain lighted and consequently, the operator is not able to define the previously selected areas directly on the leather, but only on the monitor, which results in difficulties in positioning of the new profiles.

Moreover, the use of this solution could prevent contemporary projection of two or more profiles of particularly complicated outline.

This is caused by the fact that it is necessary to respect known time of persistence of the image projected by the laser on the operator's retina: the projection of more profiles of particularly tortuous outline could require more time than the persistence time and consequently, it would be extremely difficult for the operator to visualize the profiles outline.

The above disadvantages could be avoided by the use of a plurality of laser beams, which work contemporarily to define different profiles on the leather, however, besides the very high costs, it would cause extreme difficulties in the synchronization of different light beams.

### SUMMARY OF THE INVENTION

The object of the present invention is to propose a method for optical projection of profiles on a work surface of a machine for automatic cutting of flat articles, which allows improving and speeding up the positioning of the profiles on the work surface.

Another object of the present invention is to propose a method, which allows the operator to find possible faulty areas of the leather in a rapid and precise way.

A further object of the present invention is to propose a method, which allows the leather to be mostly used, with consequent reduction of the waste.

The above mentioned objects are obtained, in accordance with the claims, by a method for the optical projection of profiles on a work surface of a machine for automatic cutting of flat articles, characterized in that it includes the following operation steps:
a) positioning of said flat article on the work surface, so that it adheres to the latter;
b) definition of at least one profile on said flat article by the optical projection, on said flat article, of a first light beam, emitted by a first light source, controlled by a control unit;
c) orientation by rotation, with respect to an axis orthogonal to said surface, and positioning of said profile on said flat article;
d) selection of said profile, previously oriented and positioned;
e) lighting of said selected profile on said flat article, by optical projection on the article of a second light beam, emitted by a matrix projector, and contemporary deactivation of said first light beam;
f) repetition of the above operation steps b, c, d, e.

### BRIEF DESCRIPTION OF THE DRAWINGS

The characteristic features of the invention will be pointed out in the following description of a preferred but not exclusive embodiment, with reference to the enclosed figures, in which:

FIG. 1 is a schematic, perspective view of a machine, which carries out the proposed method;

FIGS. 2, 3 4, 5 are schematic views of subsequent operation steps of the proposed method.

### BEST MODES OF CARRYING OUT THE INVENTION

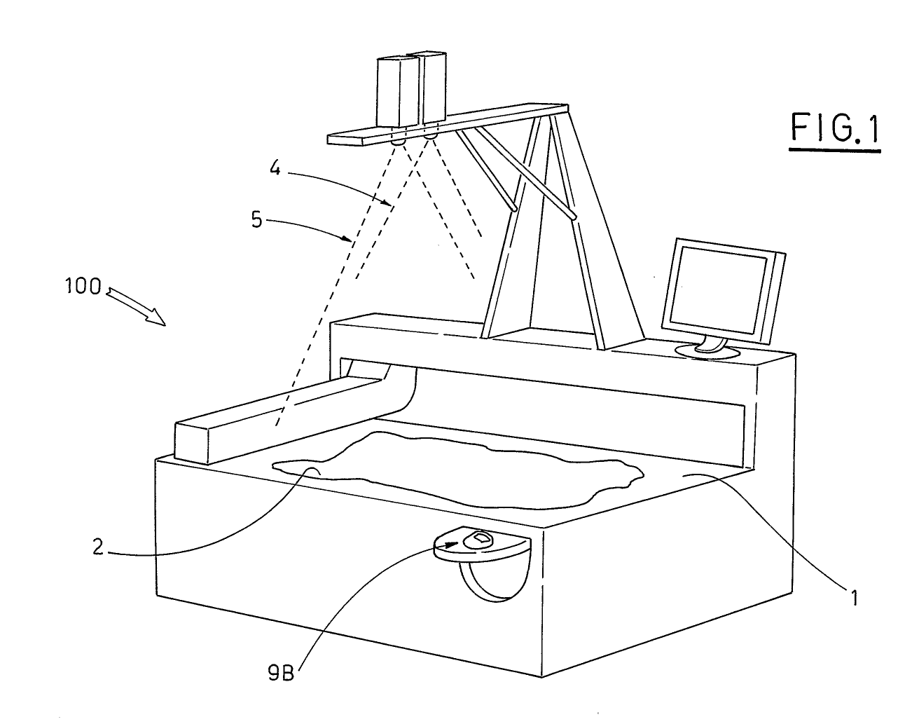

With regards to FIG. 1, the reference numeral 100 indicates a machine for automatic cutting of flat articles, equipped with a work surface 1.

For example, a flat article, to which reference will be made later on, is a leather 2.

The machine 100 has a first projector L and a second projector P, controlled by a control unit 9, 9B, and projecting respective light beams 4, 5 on the leather 2.

In particular, the first projector L emits a corresponding laser beam 4, while the second projector P (of the so-called matrix type) emits a respective light beam 5 of high light intensity.

With reference to FIGS. 1, 2, 3, 4, 5, the operation steps, characterizing the proposed method for the optical projection of profiles on the work surface 1 of the machine 100, will be described.

The leather 2 is placed on the work surface 1, having suitable holding means, of sucking type (not shown), which keep the leather adhering to the work surface (FIG. 1).

A profile 3 of a prefixed shape is defined on the leather 2 by the optical projection of the laser beam 4 on the latter.

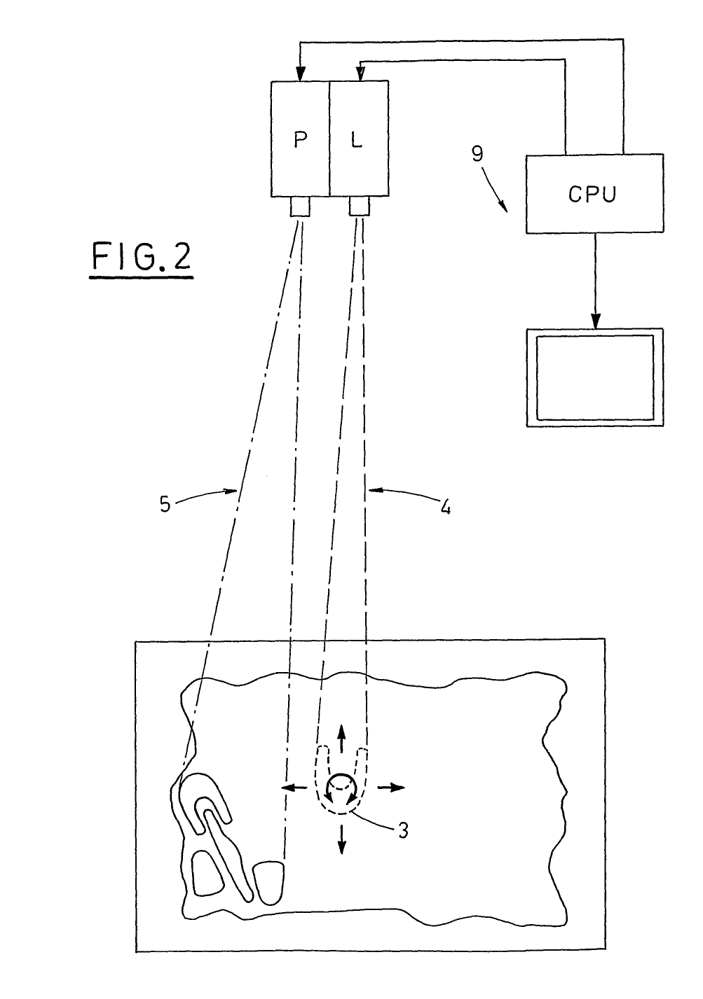

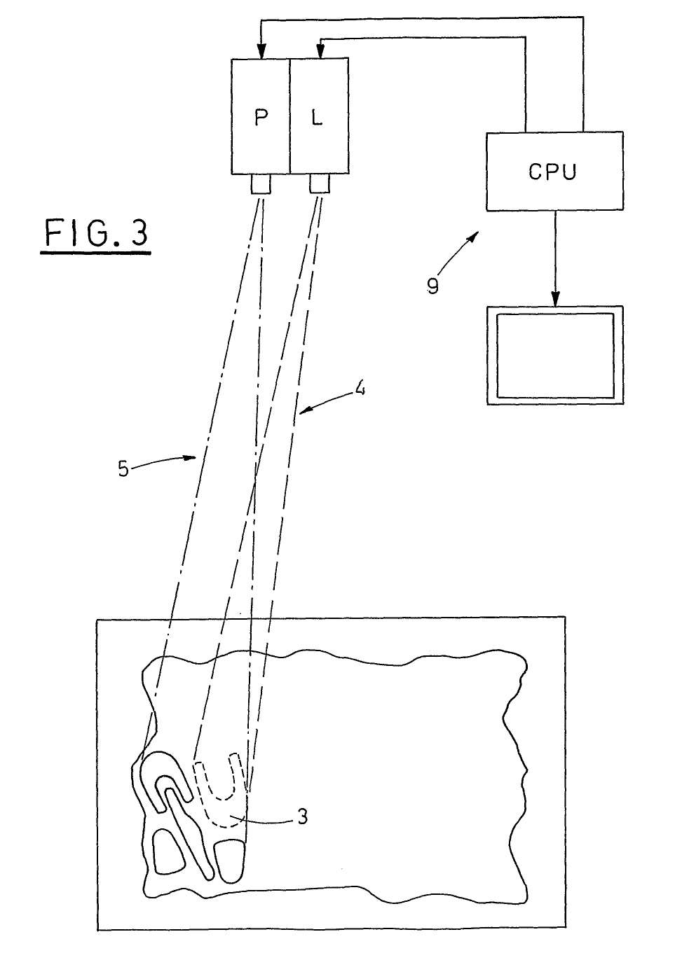

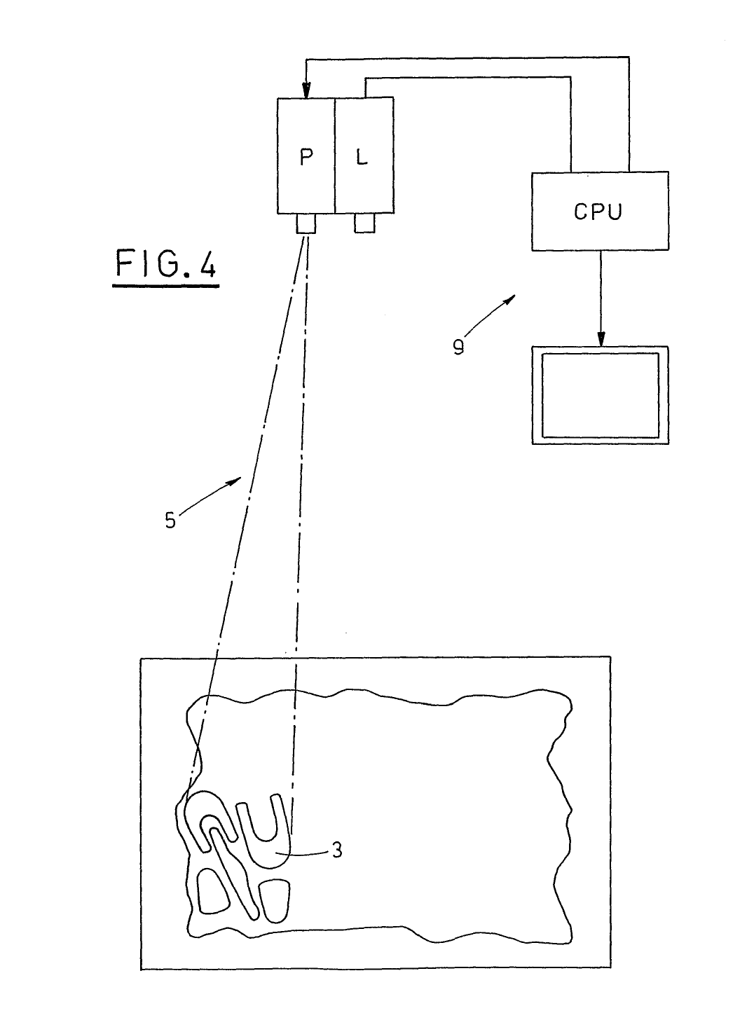

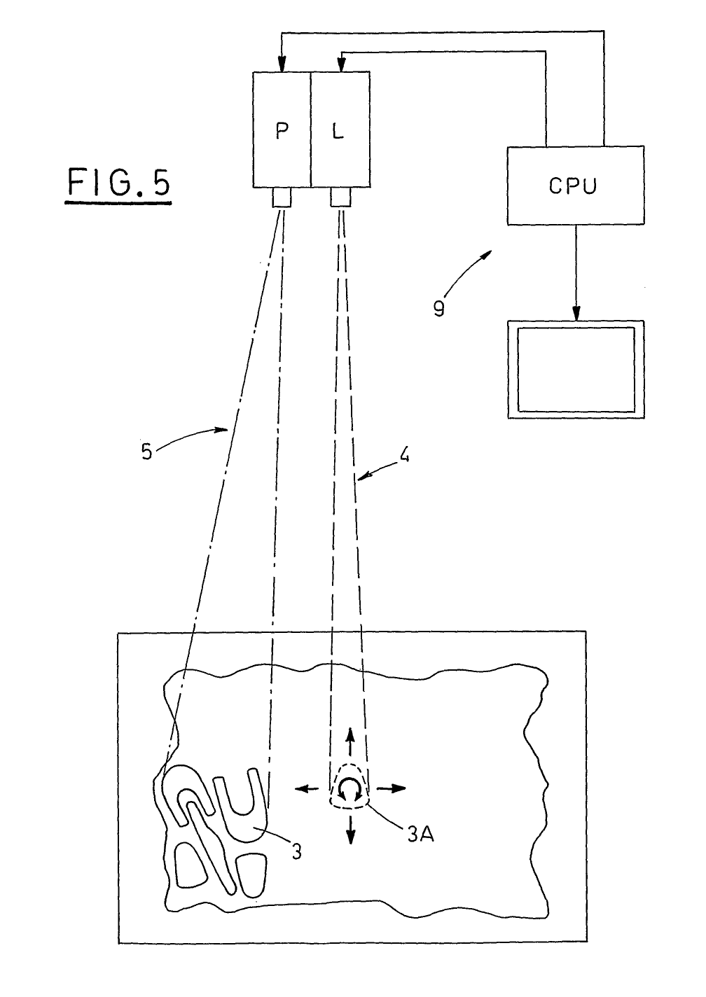

The operator acts on the means 9B for operating the control unit 9 of the projectors P, L, to adjust the profile 3 angularly with respect to an axis orthogonal to the surface 1, to place the profile, defined by the laser beam 4, on the leather 2, and finally to select it (FIGS. 2, 3).

The first projector L, which emits the laser beam 4, is deactivated after the selection of the profile 3, in step relation with the activation of the second matrix projector P, which emits the second light beam and defines the profile 3 on the leather 2 (previously oriented, positioned by the laser beam 4 and finally selected) by lighting it.

The profile 3 remains always lighted by the matrix projector P, so as to allow the operator to find the area of the leather, already occupied by the profile 3, in a rapid and easy way (FIG. 4).

The subsequent re-activating of the first projector L, allows to define on the leather 2 a second profile 3A, identical to the first one or different therefrom.

The repetition of the above mentioned operation allows the orientation, the positioning and the selection of the second profile 3A to be defined on the leather 2, as well as its definition by the matrix projector P (FIG. 5), which lights it up, after its selection.

The advantages of the proposed method result from the combined use of a matrix projector and a laser, which allows the positioning of the profiles on the work surface to be optimized and speeded up.

Moreover, the proposed method allows the operator to find possible flaws in the leather areas in a rapid and precise way, since the definition and consequent positioning of the profile on the leather is performed by the laser beam, which does not cause sight problems to the operator, when the shiny and/or dark leathers are used, independently from the lighting conditions of the work surface.

It is also to be pointed out that the above described method allows to reduce the waste to the minimum, due to the optimization of positioning of the profiles on the leather.

1. A method for the optical projection of profiles on a work surface of a machine for automatic cutting of flat articles, characterized in that it includes the following operation steps:
g) positioning of said flat article (2) on the work surface (1), so that it adheres to the latter;
h) definition of at least one profile (3, 3A) on said flat article (2) by the optical projection, on said flat article, of a first light beam (4), emitted by a first light source (L), controlled by a control unit (9, 9B);
i) orientation by rotation, with respect to an axis orthogonal to said surface (1), and positioning of said profile (3, 3A) on said flat article (2);
j) selection of said profile (3, 3A), previously oriented and positioned;
k) lighting of said selected profile (3) on said flat article (2), by optical projection on the article (2) of a second light beam (5), emitted by a matrix projector (P), and contemporary deactivation of said first light beam (4);
l) repetition of the above operation steps b, c, d, e.

2. A method, according to claim 1, characterized in that said first light beam (4) is a laser beam.

3. A method, according to claim 1, characterized in that said flat article (2) is a leather.

4. A machine for automatic cutting flat articles, characterized in that it includes: a work surface (1), which receives at least one of said flat articles (2) in spread configuration; a first projector (L), which is activated and deactivated by a control unit (9), and which optically projects at least one profile (3) on said flat article (2), to orient, position and select it; a second projector (P), which lights the previously selected profiles (3, 3A).
